(19) United States
(12) Patent Application Publication
(10) Pub. No.: US 2021/0239075 A1
(43) Pub. Date: Aug. 5, 2021

(54) DYNAMIC ROCKET NOZZLE

(71) Applicant: James Andrew Leskosek, Summerland (CA)

(72) Inventor: James Andrew Leskosek, Summerland (CA)

(21) Appl. No.: 17/075,446

(22) Filed: Oct. 20, 2020

Related U.S. Application Data
(60) Provisional application No. 62/925,603, filed on Oct. 24, 2019.

(51) Int. Cl. F02K 9/97; F02K 9/42

(52) U.S. Cl. CPC F02K 9/974; F02K 9/42; F05D 2300/10; F05D 2300/211; F05D 2230/314; F02K 9/97

(57) ABSTRACT

A rocket nozzle is made from an optimized metal lattice structure, with a hardened material applied onto the metal lattice structure so as to coat the structure and fill voids in the lattice by chemical vapor deposition. A rocket nozzle is further provided having one or more bypass lines for taking expanding gas from a combustion chamber of the rocket nozzle and redirecting the expanding gas to a skirt of the rocket nozzle to thereby manipulate the shape of a plume of expanding gas exiting the rocket nozzle. A rocket nozzle is also provided having one or more main injectors extending into the combustion chamber for injecting fuel for combustion into the combustion chamber and one or more opposing injectors oriented to direct an opposing flow of energy and gas expansion towards the main injectors, or having one or more secondary injectors arranged around the combustion chamber proximal the throat.

### FIELD

The present disclosure relates to rocket nozzles and their design and manufacture.

### BACKGROUND

A rocket nozzle is used in a rocket engine to expand and accelerate combustion gases to exit the nozzle at hypersonic velocities. The rocket nozzle turns the static high pressure, high temperature gas into rapidly moving gas at near-ambient pressure.

Some rockets may also use ion energy instead of expanding gases from propellant burning. In such cases, ion guns instead of injectors are present in the nozzle. The ion guns generate a beam of heavy ions with a well-defined energy distribution. Others use nuclear energy in the form of a nuclear reactor instead of a combustion chamber in the nozzle that releases the energy of a nuclear reaction into the skirt of the nozzle.

The making the nozzle body and components lighter and stronger has led to work in making 3D printed nozzle parts by any number of 3D printing methods like selective laser melting (SLM), spark plasma sintering (SPS) and laser metal deposition (LMD).

It is naturally desirable to optimize design of rocket nozzles to improve propulsion, or to make them stronger and more aerodynamic as well as lighter. It may also be desirable to manipulate the shape, density and energy of the energy plume as it exits the nozzle at supersonic velocity.

### SUMMARY

A rocket nozzle is provided comprising at least a skirt section made from an optimized metal lattice structure, with a hardened material applied onto the metal lattice structure so as to coat the structure and fill voids in the lattice by chemical vapor deposition.

A rocket nozzle is further provided comprising one or more bypass lines for taking expanding gas from a combustion chamber of the rocket nozzle and redirecting the expanding gas to a skirt section of the rocket nozzle to thereby manipulate the shape of a plume of expanding gas exiting the rocket nozzle.

A rocket nozzle is also provided having an axis of symmetry and comprising a combustion chamber having a back plate oriented perpendicular to the axis of symmetry at one end, and narrowing to a throat at a second end; a skirt section extending from the throat; one or more main injectors extending orthogonally from the back plate into the combustion chamber for injecting fuel for combustion into the combustion chamber and one or more opposing injectors oriented to direct an opposing flow of energy and gas expansion towards a main flow of energy and gas expanding from the main injectors to serve for amplifying gas expansion in the combustion chamber.

A rocket nozzle is further taught, having an axis of symmetry and comprising a combustion chamber having a back plate oriented perpendicular to the axis of symmetry at one end, and narrowing to a throat at a second end, a skirt section extending from the throat, one or more main injectors extending orthogonally from the back plate into the combustion chamber for injecting fuel for combustion into the combustion chamber; and one or more secondary injectors arranged around the combustion chamber proximal the throat.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is a partial cross-sectional elevation view of one embodiment of a rocket nozzle of the present disclosure;

FIG. 2 is a further view of the rocket nozzle of FIG. 1, showing energy flow from opposing injectors;

FIG. 3 is a further view of the rocket nozzle of FIG. 1, showing energy flow from a combustion chamber of the rocket nozzle, through vents, and out perforations located in a skirt section of the rocket nozzle;

FIG. 4 is a partial cross-sectional, lower perspective view of the rocket nozzle of FIG. 1;

FIG. 5A is a partial cross-sectional elevation view of another embodiment of the rocket nozzle of the present disclosure, showing examples of energy flow patterns in a combustion chamber and skirt section of the rocket nozzle;

FIG. 5B is a further view of the rocket nozzle of FIG. 5A, showing other examples of energy flow patterns in a combustion chamber and skirt section of the rocket nozzle;

FIG. 6 is a partial cross-sectional lower perspective view of the rocket nozzle of FIG. 5A;

FIG. 7 is a perspective view of the rocket nozzle of either FIG. 1 or FIG. 5A;

FIG. 8 is a further perspective view of the rocket nozzle of either FIG. 1 or FIG. 5A;

FIG. 9 is a partial cross-sectional elevation view of an alternate embodiment of the rocket nozzle of FIG. 5A;

FIG. 10A is a partial cross-sectional elevation view of yet a further embodiment of a rocket nozzle of the present disclosure;

FIG. 10B is a partial cross-sectional elevation view of an alternative arrangement of the rocket nozzle of FIG. 10A; and

FIGS. 11A, 11B and 11C are illustrations of examples of plume shapes.

The drawings are not necessarily to scale and in some instances proportions may have been exaggerated in order to more clearly depict certain features.

### DETAILED DESCRIPTION

The description that follows and the embodiments described therein are provided by way of illustration of an example; or examples, of particular embodiments of the principles of various aspects of the present disclosure. These examples are provided for the purposes of explanation, and not of limitation, of those principles and of the disclosure in its various aspects.

The present disclosure relates to a dynamic rocket nozzle its design and construction.

With reference to the present figures, the present nozzle 100 comprises a combustion chamber section 2 and a skirt section 4, which are connected at a throat section 8. Running through the nozzle 100 is a central column 10 that n part carries fuel to power the thrust of the nozzle 100.

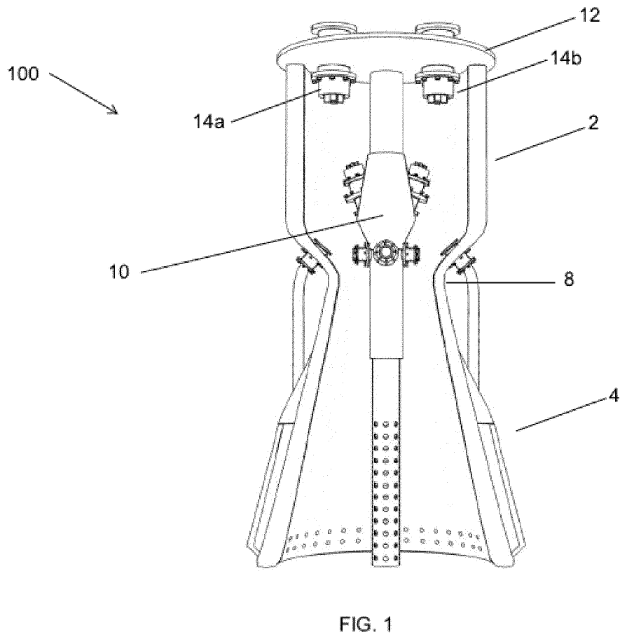

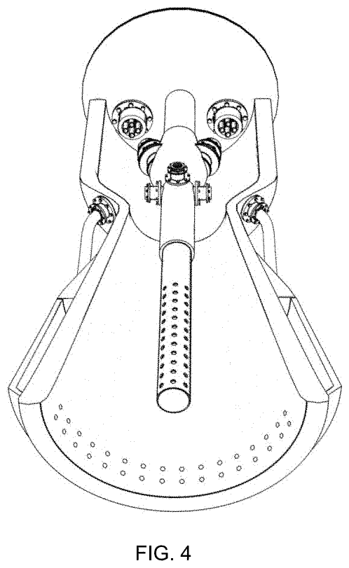

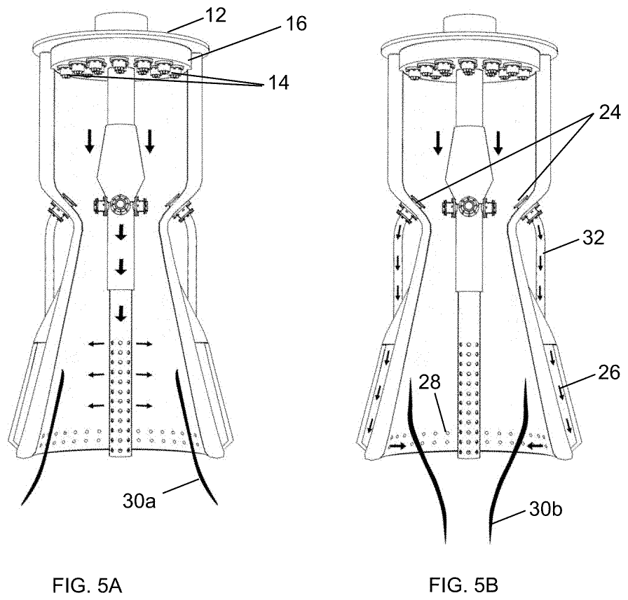

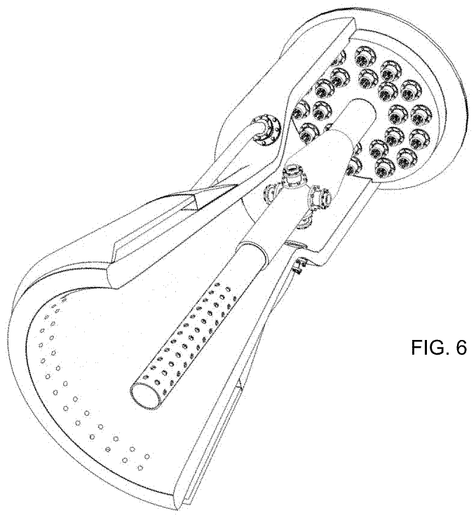

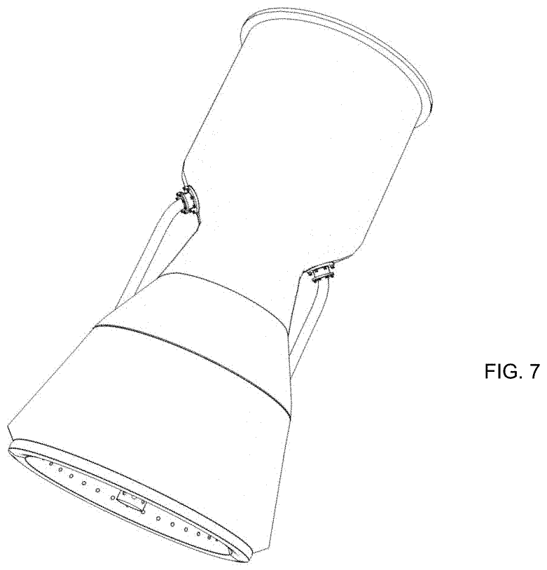

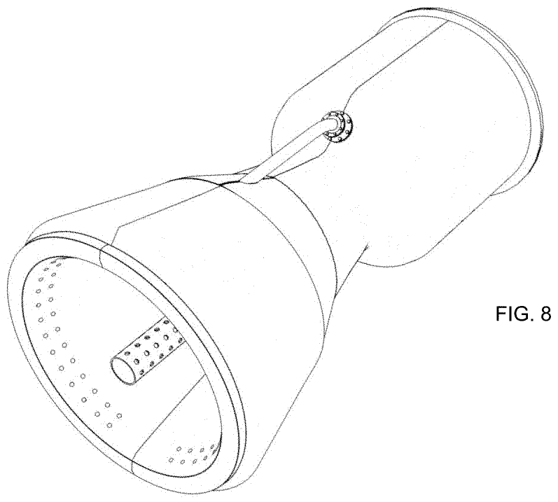

A back plate 12 covers one end of the combustion chamber section 2. One or more main injectors 14 extend through the back plate 12 and into the combustion chamber 2. FIGS. 1-4 illustrate an embodiment with a pair of main injectors 14a, 14b. FIGS. 5A to 6 illustrate an embodiment in which a manifold 16 provides fuel to multiple main injectors 14.

In the embodiment of FIGS. 1 to 4 a pair of opposing injectors 18a, 18b extend from the central column 10 into the direction of the main injectors 14a, 14b. The injectors 14, 14a, 14b, 18a, 18b, inject fuel which is combusted in the combustion chamber 2, the combusted fuel increasing in energy and pressure which in turn provides propulsion to the nozzle 100.

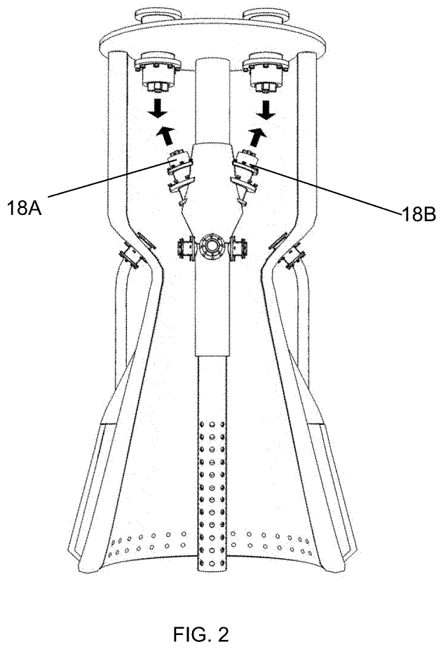

The orientation of the opposing injectors 18a, 18b in relation to the main injectors 14a,14b serve direct a counterflow of expanding gas and energy towards that flowing from the main injectors, to amplify the gas expansion and help increase specific impulse potential. They also serve to improve mixing and burning within the combustion chamber 2. The energy and fuel expansion flow are illustrated in FIG. 2.

With reference to FIGS. 5A to 6, the back plate 12 may also be provided with a manifold 16 to supply an array of multiple main injectors 14 with fuel. Preferably, no opposing injectors 18a, 18b are present and the jet of fuel combustion/energy from the array of main injectors 14 is directed down through the combustion chamber 2 to the throat 8 of the nozzle 100.

In an alternative embodiment, depicted in FIG. 9, the main injectors 14 may extend from the manifold 16 at different lengths into the combustion chamber 2. A first set of main injectors 14 that are proximal the manifold 16 serve to amplify the energy and expanding gas injected from a second set of main injectors 14 that extend further into the combustion chamber 2, to increase thrust. The second set of main injectors 14 may be affixed to elongate rigid conduits that extend from the manifold 16.

In typical rocket nozzles, the jet of fuel combustion/energy from the injectors travels down the combustion chamber 2 and through the throat 8, where the restricted cross-sectional area and volume result in increasing the pressure and force of the jet as it then enters the skirt section 4 and is released as a plume behind the rocket. Speed of the jet in the combustion chamber 2 is often at sub-sonic levels, whereas after the throat 8 the jet travels at supersonic speeds, thereby increasing thrust.

In one embodiment of the present rocket nozzle design, the plume shape, and therefore the thrust provided by the nozzle 100, is adjustable.

The present nozzle 100 provides one or more centre intakes 20 formed in the central column 10, near the throat 8 of the nozzle 100. These centre intakes 20 can be opened mechanically to receive the expanding gas in the combustion chamber 2 and direct it through a lower end of the central column 10, to be vented out of column perforations 22 formed at a lower end of the central column 10. The direction of the flow of this energy and expanding gas is illustrated in FIG. 5A, pushing and expanding the exhaust plume 30a to the side wall of the nozzle skirt 4.

In the embodiment of FIG. 5B, one or more side intakes 24 are formed in the wall of the combustion chamber 2 near the throat 8. The side intakes 24 can be opened mechanically to receive expanding gas from the combustion chamber and direct it through a cavity 26 in a side wall of the skirt section 4 through a plurality of skirt perforations 28 located at a lower end of the skirt 4 to compress the exhaust plume 30b into one narrow jet which increases the mass of the plume. In the example of FIG. 5B, bypass lines 32 are depicted for connecting side intakes 24 with skirt cavity 26, however, it would be understood by a person of skill in the art that the cavity 26 could extend through the wall of nozzle from the side intakes 24 to the skirt perforation region of the skirt 4, with no need for bypass lines 32.

In a preferred embodiment, the intakes 20/24 can take the form of a valve or of louvres.

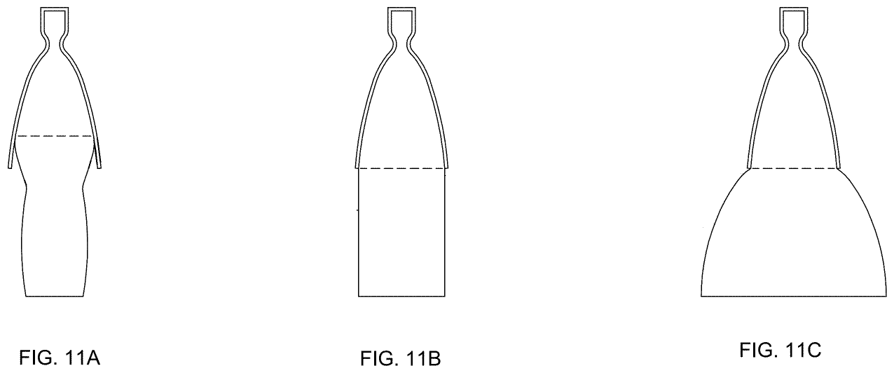

When the rocket is at sea level the nozzle can expand the exhaust plume, as in FIG. 5A to prevent the exhaust plume from becoming pinched at high ambient air pressures, since a pinched plume reduces efficiency. A pinched plume is also dangerous due to loss of directional control. When the rocket is in high orbit or in deep space, compression of the exhaust plume serves to counteract the vacuum atmosphere to be more efficient. Examples of plume shapes with no compression or expansion can be seen in FIGS. 11A, 11B and 11C, in which FIG. 11A depicts the plume shape of a rocket nozzle at sea level with a pinched plume, FIG. 11B depicts the rocket nozzle at optimum altitude with the plume being column shaped and having maximum efficiency and FIG. 11C depicts the rocket nozzle at high altitude or high orbit, with the plume continuing to expand in the vacuum atmosphere.

As well, the alternating of expanding and contracting the exhaust plume 30 can serve as an accelerator for the rocket.

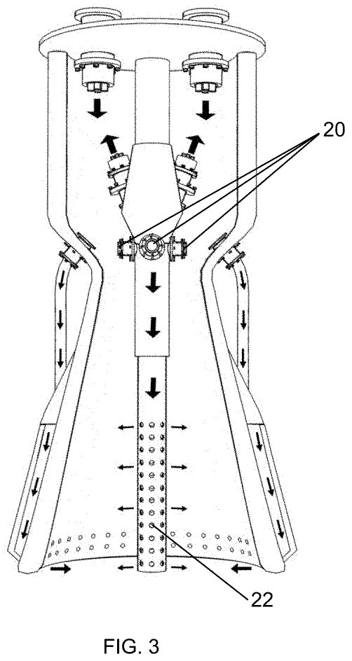

While FIG. 3 illustrates both column perforations 22 and skirt perforations 28 it would be understood that these perforations 22/28 would not likely be used at the same time, but as mentioned above could be alternated to in turn compress and expand the plume 30.

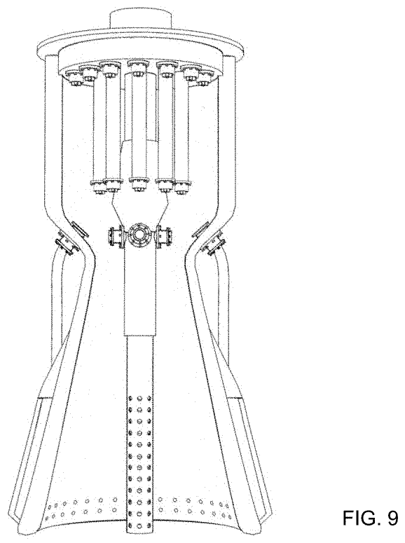

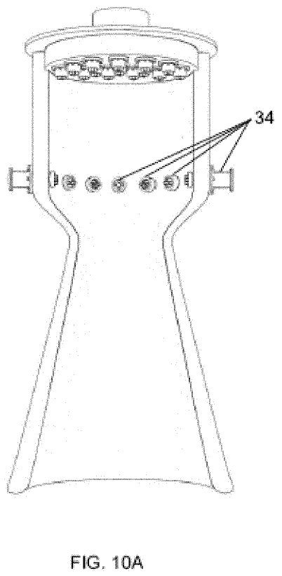

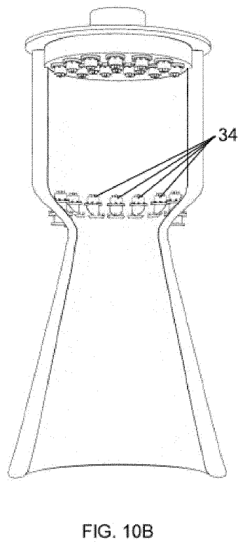

With reference to FIG. 10A, a further embodiment of the rocket nozzle 100 is depicted in which, instead of opposing injectors 18a/18b, a series of secondary injectors 34 are located around a lower end of the combustion chamber 2, just above the throat 8. The secondary injectors 34 direct a secondary flow of energy and expanding gas into the main flow of expanding gas from the main injectors 14 to thereby compress the main flow expanding gas as it enters the throat 8. This compressing of the main flow expanding gas as it enters the throat 8 serves to reduce strain and forces on the throat structure 8 of the nozzle 100, while aiding the throat section 8 in its function of compressing the expanding gas and energy before it enters the skirt 4. In this embodiment, both the secondary injectors 34 and the throat 8 aid in in increasing the pressure and force of the jet as it then enters the skirt section 4 and is released as a plume behind the rocket.

An alternate embodiment of the nozzle 100 of FIG. 10A is shown in FIG. 108, in which the secondary injectors 34 are similar in orientation as opposing injectors 18a and 18b, to direct gas expansion and energy against the gas expansion from the main injectors 14 and serve to amplify the gas expansion and help increase specific impulse potential.

In a further aspect of the present disclosure the body of the present rocket nozzle 100, including the combustion chamber 2, throat 8, skirt section 4, back plate 12 central column 10 and all injectors (14,18) and intakes (20,24) can be manufactured from a metal lattice structure, with a hard material applied thereto. The metal lattice structure in one embodiment can be 3D printed. Preferably the nozzle 100 is structurally optimized to in lattice geometry and design in terms of strength and/or stiffness-to-weight ratio. In one embodiment, the hard material can be applied to the metal lattice by chemical vapor deposition. In such case, the metal lattice serves as the cathode allowing the hard material to form around the metal structure and to fill the voids of the lattice matrix.

In a further preferred embodiment, the hard material can be diamond or synthetic diamond that is vapor deposited onto and throughout the metal lattice structure. The metal lattice framework has been found to provide some malleability and flexibility to the overall nozzle 100, to reduce rigidity which can result in structural failure.

In a further preferred embodiment, the metal lattice deposited with the hard metal can then be coated in materials such as rhenium or tungsten outer coating. The tungsten coating or rhenium coating prevents oxidation of the diamond.

In a further preferred embodiment, a silicon carbide can be used in the chemical vapor deposition process instead of diamond.

The nozzle 100 can then be polished or otherwise machined to smoothen the surfaces thereof. This form of manufacture provides a light, strong and heat resistant nozzle 100.

In an alternate embodiment, metal foam could also be used instead of an optimized metal lattice as a substitute in forming a frame onto and throughout which the diamond could be deposited.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A rocket nozzle comprising at least a skirt section made from a metal lattice structure, with a hardened material applied onto the metal lattice structure so as to coat the structure and fill voids in the lattice by chemical vapor deposition.

2. The rocket nozzle of claim 1, wherein a combustion chamber and throat of the nozzle are also made from the metal lattice structure, with the hardened material applied onto the metal lattice structure so as to coat the structure and fill voids in the lattice.

3. The rocket nozzle of claim 2, wherein the optimized metal lattice structure is a 3D printed structure.

4. The rocket nozzle of claim 3, wherein the hardened material is selected from the group consisting of diamond, synthetic diamond and silicon carbide.

5. The rocket nozzle of claim 4, wherein the body further comprises a coating selected from rhenium or tungsten.

6. The rocket nozzle of claim 1, further comprising one or more bypass lines for taking expanding gas from a combustion chamber of the rocket nozzle and redirecting the expanding gas to the skirt section to thereby manipulate the shape of a plume of expanding gas exiting the rocket nozzle.

7. The rocket nozzle of claim 1, having an axis of symmetry and comprising:
a. a combustion chamber having a back plate oriented perpendicular to the axis of symmetry at one end; and narrowing to a throat at a second end;
b. a skirt section extending from the throat;
c. one or more main injectors extending orthogonally from the back plate into the combustion chamber for injecting fuel for combustion into the combustion chamber; and
c. one or more opposing injectors oriented to direct an opposing flow of energy and gas expansion towards a main flow of energy and gas expanding from the main injectors, for amplifying gas expansion in the combustion chamber.

8. A rocket nozzle comprising one or more bypass lines for taking expanding gas from a combustion chamber of the rocket nozzle and redirecting the expanding gas to a skirt section of the rocket nozzle to thereby manipulate the shape of a plume of expanding gas exiting the rocket nozzle.

9. The rocket nozzle of claim 8, wherein the one or more bypass lines direct expanding gas out of one or more perforations in a central column of the skirt section to expand the plume.

10. The rocket nozzle of claim 8, wherein the one or more bypass lines direct expanding gas out of one or more perforations formed in an inside diameter of the skirt section to contract plume.

11. The rocket nozzle of claim 8, wherein the one or more bypass lines each comprise an intake that is mechanically openable and closable to select which bypass line is used.

12. The rocket nozzle of claim 11 wherein the intake is selected from the group consisting of a valve or a louvre.

13. A rocket nozzle having an axis of symmetry and comprising:
a. a combustion chamber having a back plate oriented perpendicular to the axis of symmetry at one end, and narrowing to a throat at a second end;
b. a skirt section extending from the throat;
c. one or more main injectors extending orthogonally from the back plate into the combustion chamber for injecting fuel for combustion into the combustion chamber; and
d. one or more opposing injectors oriented to direct an opposing flow of energy and gas expansion towards a main flow of energy and gas expanding from the main injectors to serve for amplifying gas expansion in the combustion chamber.

14. The rocket nozzle of claim 13, wherein the one or more opposing injectors are located on a central column running through the combustion chamber, throat and skirt

15. The rocket nozzle of claim 13, wherein the back plate comprises a manifold and wherein the one or more main injectors comprise an array of main injectors extending orthogonally from the manifold into the combustion chamber from the manifold.

16. The rocket nozzle of claim 15, wherein a first set of the array of main injectors extend at a first length relative to the manifold and a second set of the array of main injectors extend at a second length relative to the manifold.

17. The rocket nozzle of claim 16 wherein the first set of main injectors extend proximal the manifold and the second set of main injectors extend proximal the throat.

18. A rocket nozzle having an axis of symmetry and comprising:
a. a combustion chamber having a back plate oriented perpendicular to the axis of symmetry at one end, and narrowing to a throat at a second end;
b. a skirt section extending from the throat;
c. one or more main injectors extending orthogonally from the back plate into the combustion chamber for injecting fuel for combustion into the combustion chamber; and
d. one or more secondary injectors arranged around the combustion chamber proximal the throat.

19. The rocket nozzle of claim 18, wherein the secondary injectors serve to direct a secondary flow of energy and expanding gas to compress and narrow a main flow of expanding gas from the one or more main injectors, ahead of the throat.

20. The rocket nozzle of claim 18, wherein the secondary injectors serve to direct a secondary flow of energy and gas expansion at a main flow of energy and gas expansion from the main injectors.
